(19) United States
(12) Patent Application Publication
(10) Pub. No.: US 2004/0216139 A1
(43) Pub. Date: Oct. 28, 2004

(54) System controlling test/measurement devices on a network using markup language documents and methods thereof

(76) Inventors: Merlin A. Rhoda, Reno, NV (US); John M. Monk, Colorado Springs, CO (US)

Correspondence Address: AGILENT TECHNOLOGIES, INC., Intellectual Property Administration, P.O. Box 7599, Loveland, CO, 80537-0599, US

(21) Appl. No.: 10/224,556

(22) Filed: Aug. 21, 2002

(51) Int. Cl. G06F 9/46

(52) U.S. Cl. 719/320

(57) ABSTRACT

Defining an interface/function protocol, which parallels (mirrors) user interface functions of a computing device based upon a markup language (tag-based scripting language), to remotely interact (control/establish communication) via a network with the computing device. Accordingly, the markup-language based interface/function protocol can be used as an application programming interface to develop software applications remotely controlling computing devices.

### BACKGROUND OF THE INVENTION

1. Field of the Invention

The present invention relates to remotely and securely controlling a network device using an application interface technology at a higher level of abstraction than a byte-driven interface used to remotely control the device, thereby providing a secure remote command-driven user interface to control the device. In particular, the present invention relates to using a markup language to define an application interface to control network devices, such as network test/monitor devices, to provide a secure remote command-driven user interface.

2. Description of the Related Art

Typically, network operators use network test/monitor devices (test devices) to test/monitor data communication (traffic) of a network under test. The test devices can be controlled locally via a local command-driven interface and/or a graphical user interface with data input from a keyboard and/or a display. The network operators can also control the test devices remotely by using an Application Programming Interface (API) provided by a vendor (manufacturer) of the test devices. In particular, the network operators (i.e., customers of the test devices) use the API to develop/build test software applications regarding the network traffic by exchanging, via the API, test device commands that remotely control the test devices to perform various testing/monitoring/measurement. However, the typical API technologies are not appropriate for controlling test and measurement equipment, because typically the network operator distributes the test equipment widely across a network under testing, such as the Internet, requiring development and maintenance of increasingly complex testing software. Further, typically the test devices are different, for example, by different test device vendors, increasing complexity of the test software. Further, API versioning by the test device vendor is difficult, thereby frustrating test device updates by the vendor. Further, because of such increased complexity, debugging of software applications based upon the API is not straightforward.

A proprietary socket interface, Common Object Request Broker Architecture (CORBA) and Standard Commands for Programmable Instruments (SCPI) are the typical API technologies. The proprietary socket interface, because of its static and proprietary nature, is difficult to version, share with customers, and debug. In particular, the typical API based upon the socket interface is byte-driven (i.e., socket interface is not command-driven), requiring the network operators to develop complex software test applications using the socket interface and to acquire a knowledge base of test device commands not readily readable by users. More particularly, byte-driven refers to communication which uses fixed format binary structures to communicate. Further, increasing distributed test devices significantly increases complexity of the test applications by using the byte-driven remote interfaces. Therefore, socket interface API increases network analysis costs by demanding API expertise.

CORBA offers very little versioning support and can be too complex for the network operators. For example, when debugging a problem, it is difficult to isolate between a customer software error (network operator software error) and an API/command error. Further, CORBA does not provide sufficient security. SCPI also does not support versioning or dynamic port allocation, and uses a complex command structure difficult to use by the network operators. Further, SCPI also does not provide sufficient security.

Therefore, there is a need to remotely control a network device using an application interface technology that is easy to implement, version, secure, and cost efficient.

### SUMMARY OF THE INVENTION

According to an aspect of the present invention to define an application programming interface to remotely control a test device controlled by another interface, the invention can be attained by defining commands and parameters at a higher level of abstraction than the interface and generating XML (including any derivatives of the XML language, such as SOAP) documents based upon the commands and the parameters, thereby providing an application programming interface to control the test device.

Further, XML document elements correspond to the commands and the parameters.

According to another aspect of the present invention to control test instruments through a network, the invention can be attained by using an extensible self documenting language used to describe data to provide an application programming interface to control the test instruments through the network.

Further, XML is the self documenting language.

According to another aspect of the present invention to provide a system controlling test devices on a network, the invention can be attained by client computers in communication with the test devices via the network and generating applications to control the test devices based upon XML documents providing an application programming interface to the test devices, transmitting the XML documents to the test devices via the network, and receiving data from the test devices responsive to the transmitted XML documents.

Further, received XML documents contain the data from the test devices and also an FTP protocol is used to retreive the data from the test devices.

Further, at least one XML document exchange between a client computer and a test device provides user authentication.

Further, the XML document exchanges between the client computers and the test devices correspond to test sessions and the XML documents are encrypted, thereby providing test session security.

According to an aspect of the present invention to provide a test device in communication with a network, the invention can be attained by a programmed processor in the test device and receiving, via the network, commands described in XML documents providing an application programming interface to the test device, executing the commands, and transmitting, via the network, data responsive to execution of the commands.

According to an aspect of the present invention to define an application programming interface to remotely control computing devices on a network, the invention can be attained by defining a function protocol corresponding to user interface functions of the computing device based upon a markup language and interacting with the computing devices by exchanging documents with the computing devices, the documents generated according to the markup language and the function protocol.

### BRIEF DESCRIPTION OF THE DRAWINGS

The advantages of the invention will become apparent and more readily appreciated from the following description of the preferred embodiments, taken in conjunction with the accompanying drawings of which:

FIG. 1 is functional block diagram of a network test/monitor device control system according to an embodiment of the present invention.

FIG. 2 shows markup language source codes of application programming interface specifications to remotely control a network test/monitor device, according to an embodiment of the present invention.

FIG. 3 shows markup language source codes of other application programming interface specifications to remotely control a network test/monitor device, according to an embodiment of the present invention.

FIG. 4 shows markup language sources codes of other application programming interface specifications to remotely control a network test/monitor device, according to an embodiment of the present invention.

FIG. 5 shows markup language source codes of other application programming interface specifications to remotely control a network test/monitor device, according to an embodiment of the present invention.

FIG. 6 is a flow chart of operations to control a network test/monitor device using markup language documents, according to an embodiment of the invention.

FIG. 7 is a detailed block diagram of software processes in a device control system according to another embodiment of the invention.

FIG. 8 is a flow chart of detailed operations to establish a test session by controlling network analyzers in the device control system shown in FIG. 7.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below to explain the present invention by referring to the figures.

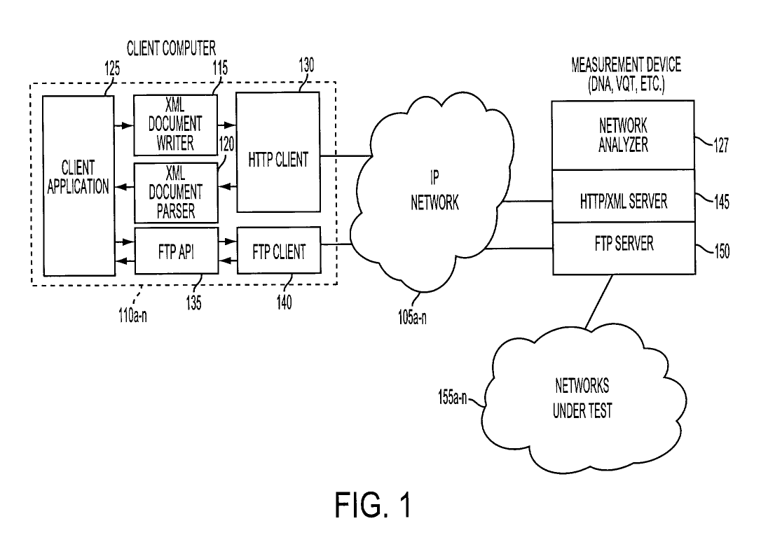

FIG. 1 is a block diagram of a network test/monitor device control system according to an embodiment of the present invention. In FIG. 1, network test (measurement and/or monitor) devices (instruments) 100a-n (test unit(s) 100a-n) are in communication with networks 105a-n and perform various tests, measurements, and/or monitoring of data on test networks 155a-n. Typically, each test unit 100 is a computer or any computing device (e.g., desktop, portable, handheld, etc.) that can communicate with the networks 105 and test networks 155 and receive/transmit, store, display and process information, using conventional techniques. In particular, the test unit 100 typically executes software performing typical testing/monitoring of data exchange/network traffic on the test networks 155 and/or measurement functions relating to data exchange/network traffic on the test networks 155. Example test units 100 include (without limitation) voice quality testers (VQTs) monitoring Real-Time Transport Protocol (RTP) packets to determine end-to-end voice quality, distributed network analyzers (DNAs) analyzing communication protocols and/or logic analyzers. Test units are available from Agilent Technologies, Inc., Palo Alto, Calif., assignee of the present application.

In FIG. 1, the network 105 can be wire or wireless having a conventional topology and a conventional architecture. The architecture of the network 105 can be, for example, a client-server using conventional communication protocols, such as the Transmission Control Protocol/Internet Protocol (TCP/IP). Further, the network 105 can be, for example, a local area network or a wide area network. The test network 155 can be any data communication technology being tested by test units 100. For example, the test network 155 can be wire or wireless having any conventional topology and any conventional architecture. The architecture of the test network 155 can be, for example, a client-server using conventional communication protocols, such as any voice network technology, T1, E1, VoIP, the TCP/IP, etc. Further, the test network 155 can be, for example, a local area network or a wide area network.

In FIG. 1, as an example using a client-server network architecture based on an IP network 105, such the Internet or an Intranet, client computer systems 110a-n are in communication with the test units 100a-n via the IP network 105. The present invention is achieved by using a markup language to define a remote byte-driven command interface of a test unit 100, thereby providing a markup-language application programming interface (API) to remotely control the test unit 100 via markup language documents. The markup-language API is at a higher level of abstraction than the remote byte-driven command interface typically used to remotely control the test unit 100. Therefore, the markup-language API provides a remote command-driven user interface to control the test unit 100. Command-driven refers to control and/or data communication which has a flexible user readable/understandable data format, in particular from a user's perspective on a control (remote) side, where locations of commands are handled and mandated by an underlying transport software. On a receiving side, an application program interprets received commands and command parameters. In particular, typically a markup language according to the Standard Generalized Markup Language (SGML) rules, such as (without limitation) Extensible Markup Language (XML), Simple Object Access Protocol (SOAP), is used to define the markup-language API. Typically, XML, including any XML extensions/derivatives, such as SOAP, is the language of choice because it is tailored for data communication (i.e., XML provides rules of defining and interpreting tags for data communication), extensibility, and easy to read format for understanding by users.

In FIG. 1, a conventional (i.e., commercially available and/or open source) XML document writer/editor 115 can be used to create and/or generate XML documents specifying commands/responses and command/response parameters (XML interface documents) at a higher level of abstraction than a remote interface (byte-driven interface) used to interface with/control the test unit 100. A conventional XML parser 120 can be used to validate and parse the XML interface documents to make available the XML data to a test-unit application 127. Therefore, the XML standard is used to define, transmit, validate and interpret test unit 100 commands, parameters and data (e.g., responses/test results) between the test unit 100 and the client computer 110, thereby providing an API to interface with/control the test unit 100. The API defined based upon XML can mirror functionality and flow of a local user interface of the test unit 100 (i.e., typically the user of the API can follow roughly a same sequence of a user of a GUI to perform a test). Although, the example embodiment uses XML to define test unit APIs, the present invention is not limited to such configuration and the present invention may be implemented using other markup languages that provide rules of defining and interpreting tags for data transmission, including other markup languages according to the SGML rules.

In FIG. 1, a client application software 125 is a test application written, for example, by a network operator to perform measurements/tests (i.e., execute test-unit applications 127 on the test units 100) relating to network traffic of the test networks 155a-n using the test units 100a-n of one or more vendors. The client application software 125 interfaces with the XML document writer 115 and the XML document parser 120 to transmit and receive control commands to control the test unit 100, respectively via the XML document writer 115 and the XML document parser 120. In an aspect of the invention, the client application 125 provides the control commands as input data to the XML document writer 115, which generates the XML interface documents based upon the input data, thereby automatically generating the XML interface documents as part of client application logic. In another aspect of the invention, the client application software 125 can use a library of XML interface documents with pre-defined control commands for the test unit 100. In another aspect of the invention, the XML document writer 115 is used to create/generate the XML interface documents and the client application 125 sends and receives the generated XML interface documents to the test unit 100 to control the test unit 100.

In FIG. 1, the client application 125 sends the generated XML interface document to the test unit 100 via a HyperText Transfer Protocol process (HTTP client 130). HTTP is used as the transport layer protocol due to its wide spread acceptance, simple interface, and security benefit by requiring a Secure Socket Layer (SSL) connection to provide secure data exchange. In another embodiment, a Secure HTTP process (S-HTTP) can also be used as the transport layer protocol supporting secure data exchange.

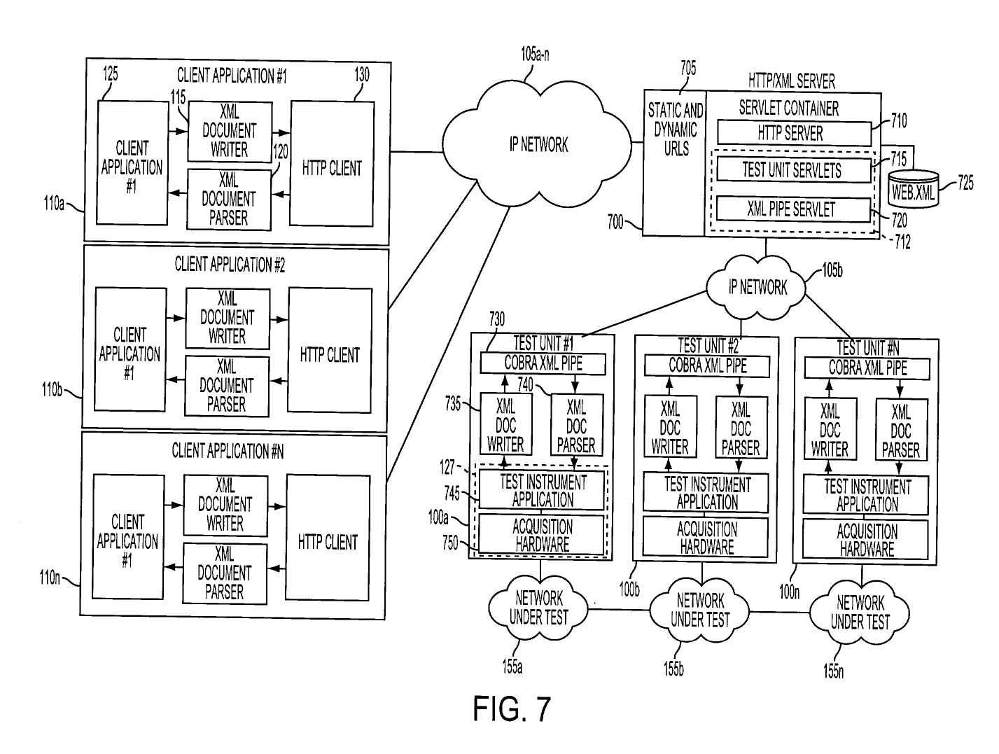

In FIG. 1, further, the client application 125 can interface with a File Transfer Protocol (FTP) API 135 via an FTP process (FTP client 140) to transmit and receive data sets (files) to/from the test unit 100. In FIG. 1, HTTP/XML server processes 145 and an FTP server process 150 in the test unit 100 correspond, respectively, to the HTTP/XML client processes 130, 115 and 120, and to the FTP client process 140, establishing network communication using conventional techniques. The present invention is not limited to the example multi-tier application architecture of client computer 110 shown in FIG. 1 and other tiered application architectures that accommodate a markup language API can be used. Further, although in the example embodiment, the HTTP/XML server processes 145 are provided in the test unit 100, the present invention is not limited to such a configuration and the server processes 145 may be integrated with the test unit 100 or executed on a separate computer (see FIG. 7) in communication with the test unit 100.

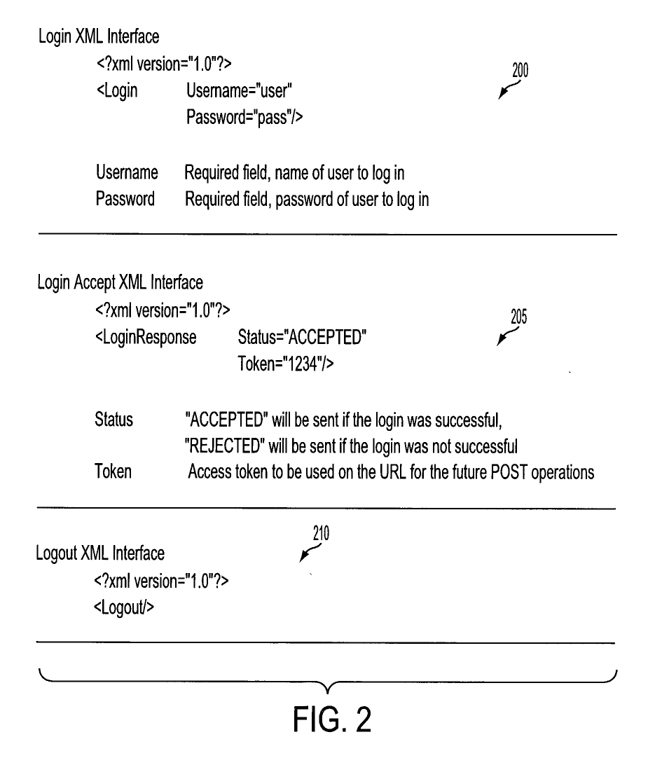

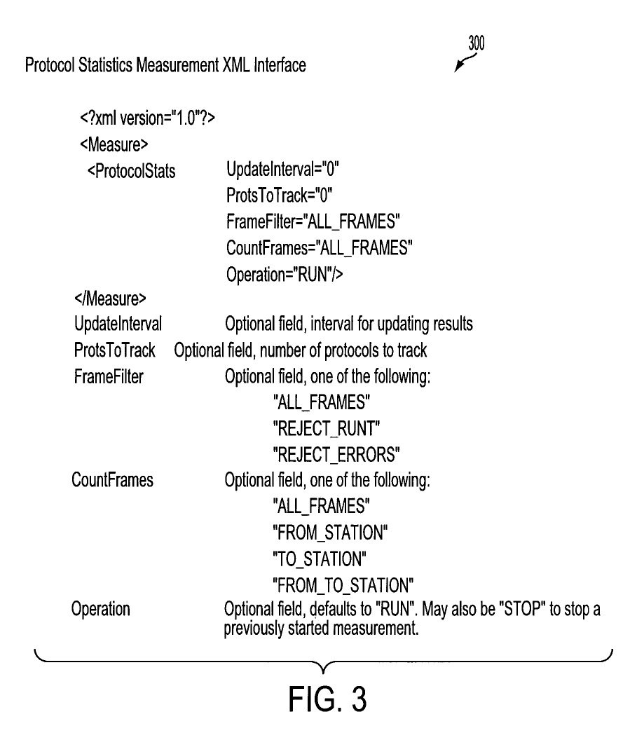

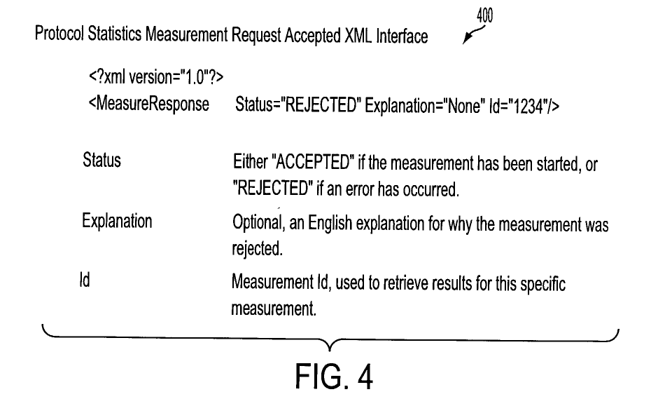

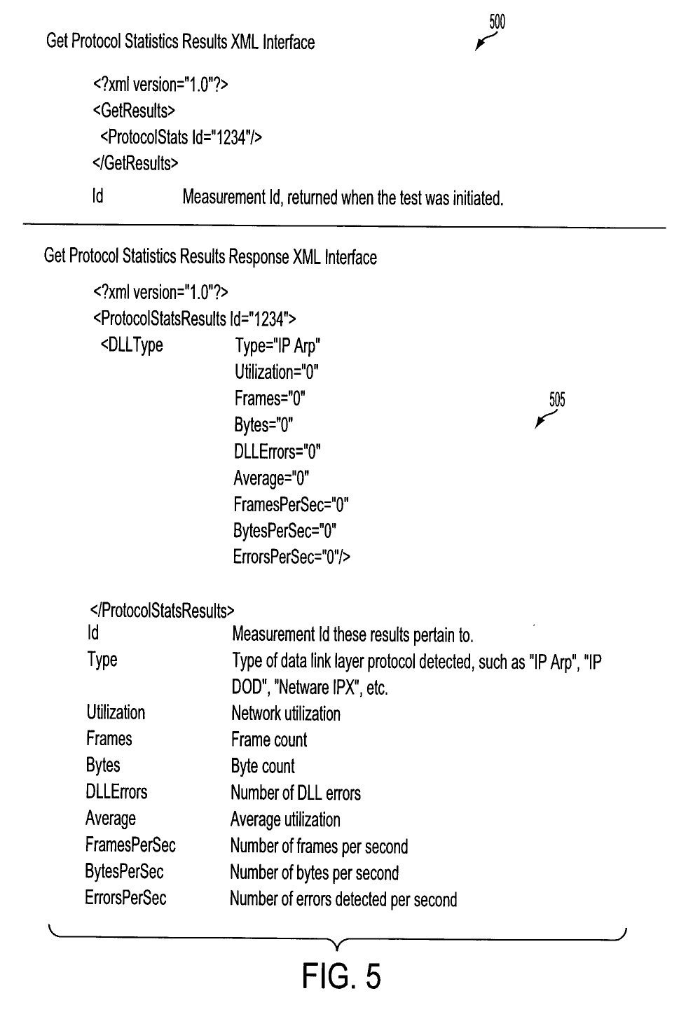

FIGS. 2-5 are markup language source codes of application programming interface specifications to remotely control a network test/monitor device, according to an embodiment of the present invention. In particular, FIGS. 2-5 are source codes of example XML interface documents, including source code comments/annotations, to control a network analyzer as the test unit 100, thereby providing an API that enables programmers (i.e., the network operators) to create network test, measurement, and/or monitoring applications via controlling the network analyzer 100. FIG. 2 is XML interface document source codes for a Login XML interface 200, a Login Accept XML interface 205 and a Logout XML interface 210. FIG. 3 is an XML interface document source code for a Protocol Statistic Measurement XML interface 300. FIG. 4 is an XML interface document source code for a Protocol Statistics Measurement Request Accepted XML interface 400. FIG. 5 is XML interface document source codes for a Get Protocol Statistics Results XML interface 500 and a Get Protocol Statistics Results Response XML interface 505. Other XML interface documents mirroring the functionality and flow of a user interface of the network analyzer 100 can be version query, idle, reboot, save frame buffer and retrieve frame information functions.

In FIGS. 2-5, typically commands/responses and command/response parameters to interface with the test unit 100 can be organized according to XML as record and field structures, respectively, at a higher level of abstraction than remote commands and command parameters of the test unit 100. Advantageously, the commands/responses and the command/response parameters can be organized as more deeply nested nodes/elements than the records and field structures. The XML based API advantageously enables programmers to easily create client applications 125 by specifying commands and command parameters using human-readable expressions (values). For example, in FIG. 3, a programmer can designate FrameFilter and CountFrames parameters of a ProtocolStats command via inputting expression options “ALL_FRAMES,” “REJECT_RUNT,” “REJECT_ERRORS,” “ALL_FRAMES,” “FROM_STATION,” “TO_STATION,” and “FROM_TO_STATION,” respectively. Advantageously, the XML document can contain annotations regarding command/response functions, command/response parameter options and other options. Further, with the XML based API the vendor of the test unit 100 can easily version (update) the API, for example, by adding new features to the API documents, with minimal impact on existing client applications 125.

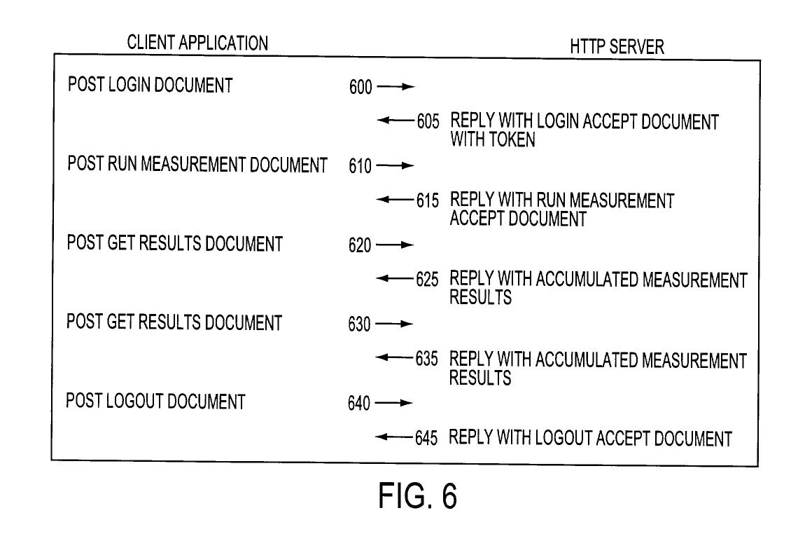

FIG. 6 is a flow chart of operations to control a network test/monitor device using markup language documents, according to an embodiment of the invention. In particular, FIG. 6 is an example HTTP session establishment and XML interface document flow between the client application 125 and the network analyzer 100 to test/measure/monitor network traffic via the network analyzer 100. At operation 600, the client application 125 posts the login XML interface document 200 via the HTTP client 130 to the HTTP/XML server 145 in the network analyzer 100. The login XML interface 200 can have a login username and password. The XML interface documents, such as the login XML interface 200, can be formed using any conventional techniques via the XML document writer 115.

In FIG. 6, at operation 605, the HTTP/XML server 145 sends to the client application 125 a reply with the login accept XML interface 205. A status field of the login-accept XML interface 205 can be either “accepted” for success or “rejected” for failure. Typically, in case of a successful login, the login-accept XML interface 205 provides a token (e.g., a cookie) to be used in subsequent HTTP posts of XML interface documents. Typically, the cookie must be used for further communication with the HTTP/XML server 145. Further, typically, the cookie expires if the cookie is not used for a predetermined amount of time, requiring another login XML interface document exchange between the client application 125 and the HTTP/XML server 145. If login is successful at operation 605, typically the HTTP session can be ended if the client application 125 logs out or the HTTP/XML server 145 times out a cookie, marking the cookie as invalid. Therefore, operations 600 and 605 perform user authentication. The XML API can provide test session security by using available security measures of the HTTP client-server architecture.

In FIG. 6, at operation 610, the client application 125 posts a run-measurement command with the protocol-statistics-measurement XML interface 300 to the HTTP/XML server 145. At operation 620, the HTTP/XML server 145 receives and parses the run-measurement XML interface 300 and makes available the XML data as input commands to the test-unit application 127. The run-measurement XML interface 300 defines a control node “measure,” which corresponds at a higher level of abstraction to a remote interface command recognizable by the network analyzer 100. The run-measurement XML interface 300 further defines a parameter node “ProtocolStats” of the “measure” control node, which corresponds at a higher level of abstraction to optional parameters of the remote interface command. The parameter node “ProtocolStats” contains attributes and acceptable attribute values. The attribute names “UpdateInterval,” “ProtsToTrack,” “FrameFilter,” “CountFrames,” and “Operation,” describe at a higher level of abstraction functions of the corresponding optional parameters of the remote interface command. The attribute values of an attribute (parameter) describe at a higher level of abstraction available functions of a corresponding optional parameter of the remote interface command.

In FIG. 6, at operation 615, the HTTP/XML server 145 receives and parses the run-measurement XML interface 300 and makes available the XML data contained in the run-measurement XML interface 300 as input commands to the test-unit application 127. At operation 615, the test-unit application 127 posts a run-measurement-accept reply with the protocol-statistics-measurement-request-accepted XML interface 400. When, at operation 615, the HTTP/XML server 145 receives the run-measurement XML interface 300, the server 145 can either accept or reject the request based on the user's security level and/or validation of input commands and parameters contained in the run-measurement XML interface 300. The run-measurement-accept XML interface 400 defines a “MeasureResponse” node containing attributes “Status,” “Explanation,” and “Id,” which provide the client application 125 with reply information. For example, the client application 125 uses the “Id” attribute value to request measurement results.

In FIG. 6, at operation 620, the client application 125 posts a get-results command with the get-protocol-statistics-results XML interface 500 to the HTTP/XML server 145. At operation 625, the HTTP/XML 145 receives and parses the get-results XML interface 500 and makes available the received XML data as input commands to the test-unit application 127. The “ProtocolStats Id” attribute can contain the “Id” attribute value returned by the test-unit application 127 in the run-measurement-accept XML interface 400 at operation 615 in reply to initiation of the test. At operation 625, the test-unit application 127 posts an accumulated-measurement-results reply with the protocol-statistics-results-response XML interface 505. In particular, at operation 625, the test-unit application 127 executes requested measurement processes responsive to the get-results XML interface 500 and accumulates corresponding measurement results, which are contained in the accumulated-measurement-results XML interface 505. For example, the accumulated-measurement-results XML interface 505 can define DLLType nodes for each data link layer protocol detected by the network analyzer 100.

In FIG. 6, in another embodiment, at operation 625 the test-unit application 127 can accumulate the measurement results in data files, for example, located in the network analyzer 100 as specified by the posted get-results XML interface 500. The client application 125 can retrieve the accumulated results via an FTP connection/session with a FTP server 150 in the network analyzer 100. In particular, the client application 125 establishes the FTP connection to the FTP server 150 via the FTP API 135 and the FTP client 140. The test-unit application 127 can notify the client application 125 of availability of measurement result files via posting the get-results-response XML interfaces 500. Advantageously, the client application 125 can manage the network analyzer 100 via XML interface documents to initiate test, accumulates test results and retrieve the test results either via reply XML interface documents and/or FTP in case of large data retrievals, such as data frame retrieval.

In FIG. 6, within the test session initiated at operation 600, operations 630 and 635 can be other XML interface documents flowing between the client application 125 and the network analyzer 100 to test/measure/monitor network traffic by managing the network analyzer 100.

In FIG. 6, at operation 640, the client application 125 can end the test session by posting the logout XML interface 210 to the HTTP/XML server 145. At operation 650, the HTTP/XML server 145 receives and parses the logout XML interface 210 and makes available the XML data as input commands to the test-unit application 127. At operation 645, the test-unit application 127 can post a logout accept XML interface (not shown). Further, at operation 645, the HTTP/XML server 145 invalidates the issued cookie to end the test session.

In FIG. 6, operations controlling a network test/monitor device based upon the XML interface documents shown in FIGS. 2-5 are example operations and the present invention is not limited to such XML interface document flow and/or the XML interface documents of FIGS. 2-5. Accordingly, other XML type interface documents that define and/or contain (encapsulate) remote interface commands of test units 100 according to the XML rules can be used. The remote interface commands of test units 100 can be described, according to the XML rules, based upon metaphors of a database structure, nested nodes/elements, etc., corresponding to functionality and flow of user interfaces of the test units 100.

FIG. 7 is a detailed block diagram of software processes in a device control system according to another embodiment of the invention. The HTTP/XML server 700 corresponds to the HTTP/XML server 145. The HTTP/XML server 700 is embodied in a computer system and is in communication with the client computer system 100 and the test units 100a-n via the networks 105a-n and 155a-n, respectively. Typically, each test unit 100 is a computer or any computing device that can communicate with the test networks 155 and receive/transmit, store, display and process information, using conventional techniques. In particular, each test unit 100 typically executes software performing typical testing/monitoring of data exchange/network traffic on the test networks 155 and/or measurement functions relating to data exchange/network traffic on the test networks 155.

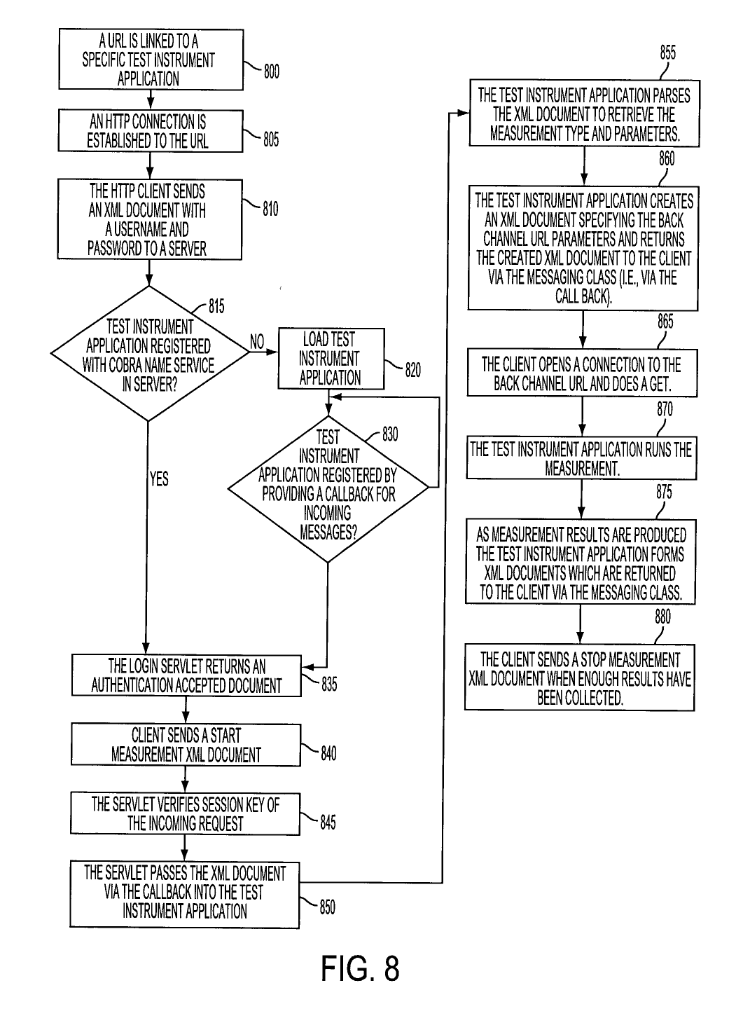

FIG. 8 is a flow chart of detailed operations to establish a test session by controlling network analyzers in the device control system shown in FIG. 7. As an example using a client-server network architecture on IP networks 105a, 105b, such the Internet or an Intranet, client computer systems 11 Oa-n are in communication with network analyzers 100a-n as the test units 100a-n via the HTTP/XML server 700. In particular, the client computer systems 110a-n are in communication with the HTTP/XML sever 700 via the IP network 105a and the HTTP/XML server 700 is in communication with the test units 100a-n via the IP network 105b. At operation 800, the client application 125 links to a specific test-unit application 127 via a Universal Resource Locator (URL). In particular, the client application 125 sends, via the network 105a, a URL link request message to a static and dynamic URLs process 705 in the HTTP/XML server 700. Regarding the test-unit application 127, typically the test unit application 127 has a test instrument application 745 embodying testing, measurement, and/or monitoring software processes regarding the network traffic on the test networks 155. Further, typically, the test-unit application 127 has acquisition hardware 750 embodying testing, measurement, and/or monitoring hardware processes regarding the network traffic on the test networks 155.

In FIG. 8, at operation 805 an HTTP server process 710 of the HTTP/XML server 700, which is in communication with the static and dynamic URLs process 705, establishes an HTTP connection to the received URL request. At operation 810, the client application 125 sends, via the XML document writer 115 and the HTTP client 130, the login XML interface document 200 to the HTTP/XML server 700. The login XML interface 200 can contain a username and password or other user authentication information.

In FIG. 8, at operation 815, the HTTP server 710 receives and provides the login XML interface 200 to servlet processes 712. The servlet processes 712 comprise test unit servlets 715 and an XML pipe servlet (e.g., CORBA name service) 720, which provide XML document writing, parsing, validation, and general security (login) services in connection with the test session. At operation 815, the servlet processes 712 check if an XML communication pipe can be established between the server 700 and the test unit 100 by determining if the requested test-unit application 127 (requested at operation 800) is registered with a CORBA name service. If, at operation 815, the test-unit application 127 is not registered with the CORBA name service, at operation 820, the XML pipe servlet 720 sends a load-test-application request via the network 105b to a CORBA XML pipe process 730 of the test unit 100. At operation 830, the XML pipe servlet 720 waits until the CORBA XML pipe process 730 registers the requested test-unit application 127 by providing the XML pipe servlet 720 a callback for incoming messages (a messaging class).

In FIG. 8, after the test-unit application 127 is registered with the CORBA name service, at operation 835, the servlet processes 712 return the login-accept XML interface document 205 to the client application 125. At operation 840, the client application 125 sends the protocol-statistics-measurement XML interface document 300 to initiate a test. At operation 845, the test unit servlet 715 verifies session key of the incoming measurement request 300. At operation 850, the XML pipe servlet 712 passes the incoming protocol-statistics-measurement XML interface document 300 via the callback into the test-unit application 127 (e.g., the test instrument application 745 and/or the acquisition hardware 750).

In FIG. 8, at operation 855 the test-unit application 127 receives and parses the protocol-statistics-measurement XML interface document 300 (for example, via XML doc parser 740) to retrieve command information, such as measurement type and parameters. At operation 860, the test-unit application 127 creates the protocol-statistics-measurement-request-accepted XML interface document 400 (for example, via the XML doc writer 735) and returns the created XML document 400 to the client application 125 via the call back. At operation 860, the XML interface document 400 specifies back channel URL parameters in the “Id” field of the XML interface document 400. At operation 865, the client application 125 opens a connection to the back channel URL and does a get via sending the get-protocol-statistics-results XML interface document 500. At operation 870, the test-unit application 127 receives the get and runs the measurement.

In FIG. 8, at operation 875, as measurement results are produced, the test-unit application 127 forms the get-protocol-statistics-results-response XML interface documents 505 and sends the formed XML documents 500 containing results to the client application 125 via the messaging class. At operation 880, when enough results have been collected, the client application 125 sends a stop XML interface document, such as the logout XML interface document 210, to end the test session.

In FIG. 8, at operations 865-875, the client application 125 can retrieve frame buffers of the test networks 155. The frame buffer data can be contained/described in XML documents, which increase readability and analysis efficiency on the client computer 110 side. In particular, the XML documents describing the frame buffer data are sent to the client application 125 for processing (e.g., display, output, analysis, etc.). However, because frame buffer data can be large, optionally the client application 125 can control the test-unit application 127 to save buffer data in files, for example, in the test units 100, using known techniques. The client application 125 can retrieve the saved frame buffer data via FTP sessions instead of using XML documents to increase transmission efficiency. Although, the client application 125 can also retrieve the saved frame buffer data via HTTP file transfer sessions.

As shown in FIGS. 7 and 8, typically components of the invention are servlets, a messaging class, an application loader and an XML document library. A servlet container, such as the servlet processes 712, serves XML documents via an HTTP connection to the client computers 110 that execute the client (test) applications 125. Typically, the servlets process logins, manage sessions, accept measurement start/stop/etc. commands, and manage asynchronous back channels for returned data from the test-unit applications 127 of the test units 100. Communication to/from the servlets is typically done via the message class. The application loader binds URL's to specific test-unit applications 127 and optionally can load the test-unit applications 127 in each test unit 100 as requested when the URL is referenced by the client applications 125. The XML document library contains the XML based API source codes.

Using XML as an API for test and measurement equipment allows self-contained, self-describing, modular applications that can be published, located, and invoked across the Web. Testing software applications based upon the XML API can perform various functions, which can be anything from simple requests to complicated coordinated operations. Using XML as the underlying mechanism for an API for test and measurement equipment solves the problems of: not having a straightforward mechanism to control test and measurement equipment over the Internet; not being able to efficiently support a wide variety of test unit customers or a wide variety of testing software applications of the customers using the test units or a wide variety of test-unit applications (i.e., XML enables easier integration of test and measurement equipment with other existing systems); and difficulty in writing test application software that access API's other than a markup language API, such as an XML API.

Other advantages of the invention are that XML is a widely used and well documented language, ideally suited for describing data. In particular, XML can serve as a vehicle for integrating different computer systems, and in this case, test and measurement equipment. XML based API can support easy API versioning because XML API documents can be easily changed using a text editor and user readability of the XML API documents. For example, typically versioning is supported by extending the XML API language as new test unit features are added. The deprecated API commands can still be interpreted and acted upon. One way that XML makes this possible is by allowing the structure describing the remote interface commands to be expanded without invalidating a deprecated version of the structure. For example, the XML element structure for a login XML interface document:

<people>

<employee>

<name>Merlin Rhoda</name>

</employee>

</people>
can be versioned to include a new field ‘title’ as follows:
<people>

<employee>

<name>Merlin Rhoda</name>
<title>Software Engineer</title>

</employee>

</people>

The test-unit application software that parses this XML document (for example, the XML doc parser 740) can accept either version, and if no title is specified the software can choose to take special action or not. In contrast to using the XML API, in a byte-driven sockets interface there would be a need to define another command handler for the test-unit application software to solve this same problem (twice the software effort to version the command). This increases number of command handler implementations, leaving test-unit application software open to additional bugs and security holes, for example, in case of login XML interface documents.

Further, XML based API can be straight forward to debug because one can easily determine if a problem lies in the client application 125 or in the API commands issued to the test-unit application 127 by reading the exchanged XML documents.

Further, if a test unit already has a native API of some sort other than XML (for example, an existing command handler for a byte-driven sockets interface), then a translator program can convert XML commands into the native API commands, obviating modification of the test-unit software.

Although the example embodiments describe an XML API to control test units, the present invention is not limited to such a configuration. The present invention can be attained be defining an interface/function protocol, which parallels (mirrors) user interface functions of a computing device based upon a markup language (tag-based scripting language, self documenting language) and to remotely interact (control/establish communication) with the computing device via a network by exchanging interface/function protocol documents according to the markup language. Accordingly, the markup-language based interface/function protocol can be used as an API to develop software applications remotely controlling computing devices.

According to the present invention, remote test software can control test devices by forming XML document requests. Typically, HTTP is used as the transport to exchange the XML documents with the test devices. HTTP has wide spread acceptance on the Internet, including the World Wide Web, a simple interface and security benefits by providing a secure socket layer. Therefore, typically, the XML documents are sent over an HTTP connection to a server in communication with the test devices. The server will return data to the remote test software via a set of response XML documents. Available HTTP extensions, such as the secure socket layer (SSL) packet encryption, may be enabled for test session security. Further, at least one XML document exchange can be for user authentication. A user performing tests (via the remote test software) can be required to supply a username and password that was previously configured on the test devices. Further, file transfers may be accomplished using HTTP and/or FTP, allowing the remote test software to retrieve large data sets without going through XML and to place configuration files onto the server.

Although a few example embodiments of the present invention have been shown and described, it would be appreciated by those skilled in the art that changes may be made in the example embodiments without departing from the principles and spirit of the invention, the scope of which is defined in the claims and their equivalents.

What is claimed is:

1. A method of defining an application programming interface to remotely control a test device controlled by another interface, comprising:
defining commands and parameters at a higher level of abstraction than the interface; and
generating XML documents based upon the commands and the parameters, thereby providing an application programming interface to control the test device.

2. The method of claim 1, wherein XML document elements correspond to the commands and the parameters.

3. A method of controlling test instruments through a network, comprising using an extensible self documenting language used to describe data to provide an application programming interface to control the test instruments through the network.

4. The method of claim 3, wherein XML is the self documenting language.

5. A system controlling test devices on a network, comprising:
client computers in communication with the test devices via the network and generating applications to control the test devices based upon XML documents providing an application programming interface to the test devices, transmitting the XML documents to the test devices via the network, and receiving data from the test devices responsive to the transmitted XML documents.

6. The system of claim 5, wherein received XML documents contain the data from the test devices.

7. The system of claim 5, wherein an FTP and/or HTTP protocol is used to receive the data from the test devices.

8. The system of claim 5, wherein at least one XML document exchange between a client computer and a test device provides user authentication.

9. The system of claim 5, wherein the XML document exchanges between the client computers and the test devices correspond to test sessions and the XML documents are encrypted, thereby providing test session security.

10. A test device in communication with a network, comprising:
a programmed processor receiving, via the network, commands described in XML documents providing an application programming interface to the test device, executing the commands, and transmitting, via the network, data responsive to execution of the commands.

11. The test device of claim 8, wherein the programmed processor further converts the commands into compatible data of the test device to execute the commands.

12. A method of defining an application programming interface to remotely control test computing devices on a network, comprising:
defining a function protocol corresponding to user interface functions of the computing device based upon a markup language.

13. The method of claim 12, further comprising interacting with the test computing devices by exchanging documents with the test computing devices, the documents generated according to the markup language and the function protocol.
